(19) United States
(12) Patent Application Publication
(10) Pub. No.: US 2022/0250635 A1
(43) Pub. Date: Aug. 11, 2022

(54) ATTITUDE CONTROL DEVICE

(71) Applicant: HONDA MOTOR CO., LTD., Tokyo (JP)

(72) Inventor: Shuichi OKADA, Tokyo (JP)

(21) Appl. No.: 17/666,718

(22) Filed: Feb. 8, 2022

(30) Foreign Application Priority Data
Feb. 10, 2021 (JP) 2021-019919

(51) Int. Cl. B60W 50/038; B60W 30/02; B60W 50/04

(52) U.S. Cl. CPC B60W 50/038; B60W 30/02; B60W 50/045; B60W 2520/14; B60W 2520/105; B60W 2710/20; B60W 2520/10; B60W 2520/12; B60W 2420/42; B60W 2720/406; B60W 2520/125

(57) ABSTRACT

An attitude control device includes an attitude controller that controls a controlled device such that a traveling attitude of a vehicle is converged to a target attitude, a limiter that limits output of the attitude controller when abnormality is detected in at least one of detectors configured to detect control parameters used by the controlled device or the attitude controller, and a yaw rate detector that detects a yaw rate of the vehicle. The limiter sets a second limit value for a control amount that causes the yaw rate to change in a direction away from 0, to a value smaller than a first limit value for a control amount that causes the yaw rate to change in a direction toward 0.

### CROSS-REFERENCE TO RELATED APPLICATION

This application is based upon and claims priority from the Japanese Patent Application No. 2021-019919, filed on Feb. 10, 2021, the entire contents of which are incorporated herein by reference.

### BACKGROUND OF THE INVENTION

### 1. Field of the Invention

The present invention relates to an attitude control device.

### 2. Description of the Related Art

In an attitude control device that controls an attitude of a vehicle in a horizontal direction, it is conceivable that a control amount is limited by a limit value to such a control amount that any driver can easily correct vehicle behavior in failure of sensors and the like depending on vehicle speed.

JP2000-272492A discloses a technique in which attitude control of vehicle for suppressing side-slip or spin of a traveling vehicle is suppressed when abnormality is detected in a yaw rate sensor, a horizontal acceleration rate sensor, or the like and second attitude control of vehicle different from control in the normal case is performed when the vehicle is determined to be in a predetermined state (unstable state).

### SUMMARY OF THE INVENTION

However, limiting the control amount by the limit value to such a control amount that any driver can easily correct vehicle behavior in failure of sensors and the like as described above causes the control amount to be limited in consideration of a worst-case mode irrespective of a control direction. Accordingly, the control amount is excessively limited and there is a concern of a decrease in control performance.

Moreover, in the technique of JP2000-272492A, the second attitude control of vehicle is performed after the vehicle is determined to be in an unstable state. Accordingly, there is a room for improvement in stabilization of the vehicle.

An object of the present invention is to provide an attitude control device that can maintain high control performance also when abnormality is detected in a detector configured to detect a control parameter.

An attitude control device according to the present invention includes an attitude controller that controls a controlled device such that a traveling attitude of a vehicle is converged to a target attitude, a limiter that limits output of the attitude controller when abnormality is detected in at least one of detectors configured to detect control parameters used by the controlled device or the attitude controller, and a yaw rate detector that detects a yaw rate of the vehicle. Here, the limiter sets a second limit value for a control amount that causes the yaw rate to change in a direction away from 0, to a value smaller than a first limit value for a control amount that causes the yaw rate to change in a direction toward 0.

The present invention can provide an attitude control device that can maintain high control performance also when abnormality is detected in a detector configured to detect a control parameter.

### BRIEF DESCRIPTION OF THE DRAWINGS

FIG. 1 is a system configuration diagram of a vehicle according to an embodiment of the present invention.

FIG. 2 is a functional block diagram of an ATTS-ECU of the vehicle according to the embodiment of the present invention.

FIG. 3 is a concept graph explaining limit values of a control amount of the left-right drive force distribution device 13 by the ATTS-ECU in the vehicle according to the embodiment of the present invention.

FIG. 4 is a plan view of a vehicle traveling in a lane.

FIG. 5 is a functional block diagram of means for calculating an image yaw rate executed by a yaw rate detector in the vehicle according to the embodiment of the present invention.

### DETAILED DESCRIPTION OF THE EMBODIMENTS

An embodiment of the present invention is described below with reference to the drawings.

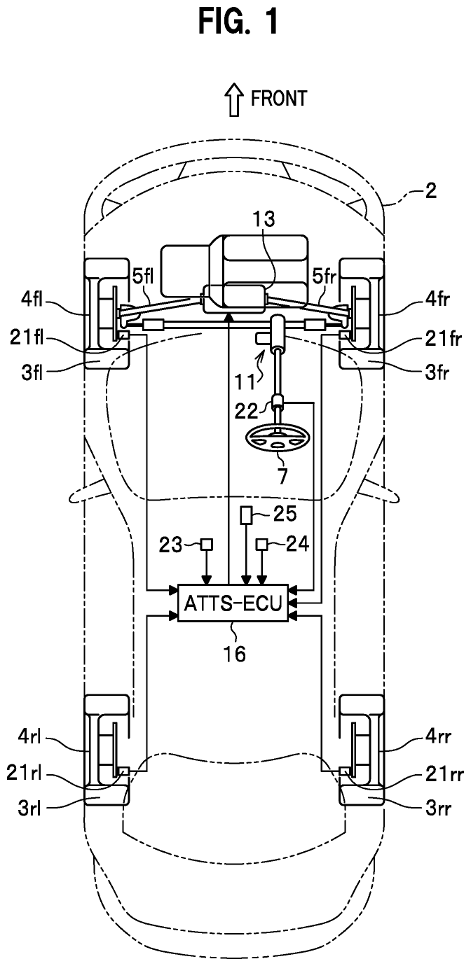

First, a device configuration of a vehicle is described with reference to FIG. 1. FIG. 1 is a system configuration diagram of a vehicle according to the embodiment of the present invention. In the description, four wheels and members arranged to correspond to these wheels are denoted by reference numerals to which letters indicating front, rear, left, and right are attached, and are described as, for example, wheel 4fl (front left), wheel 4fr (front right), wheel 4rl (rear left), and wheel 4rr (rear right). When the wheels and the members are to be collectively referred to, they are described as, for example, wheels 4. The same applies also to tires denoted by reference numeral 3 and wheel speed sensors denoted by reference numeral 21 to be described later.

As illustrated in FIG. 1, a vehicle 1 includes four wheels 4 to which tires 3 are attached, on front, rear, left, and right sides of a vehicle body 2. An electric power steering (EPS) 11 that performs steering assist, an active torque transfer system (ATTS, left-right drive force distribution device) 13 that variably distributes drive force to the left and right front wheels 4fl and 4fr (left and right drive shafts 5fl and 5fr), and an ATTS-ECU 16 (attitude control device) that drive-controls the left-right drive force distribution device 13 (controlled device) are mounted in the vehicle 1.

The vehicle 1 includes vehicle speed sensors 21 that detect wheel speed for the respective wheels 4 and also includes a steering angle sensor 22 that detects a steering angle of a steering wheel 7, a yaw rate sensor 23 that detects an actual yaw rate of the vehicle body 2, a horizontal acceleration rate sensor 24 (horizontal acceleration rate detector) that detects a horizontal acceleration rate of the vehicle body 2, and the like at appropriate locations.

The left-right drive force distribution device 13 is formed of paired planetary gear mechanisms, paired hydraulic clutches, a hydraulic pressure control valve that drive-controls the hydraulic clutches, and the like and continuously changes distribution of drive force to the left and right front wheels 4 depending on a drive current from the ATTS-ECU 16. The ATTS-ECU 16 includes a microcomputer, a ROM, a RAM, a peripheral circuit, an input-output interface, various drivers, and the like and is connected to other various control devices, the left-right drive force distribution device 13, and the sensors 21 to 24 via a communication line (control area network (CAN) in the embodiment).

A camera 25 that captures a forward-view image of the vehicle 1 is provided near a room mirror or the like of the vehicle 1.

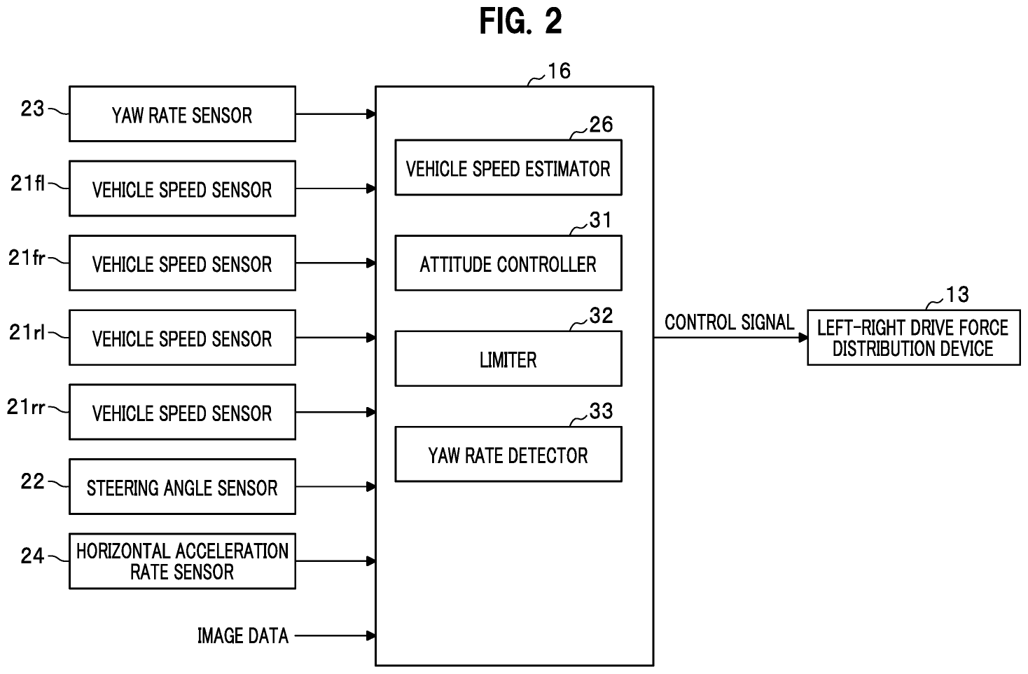

FIG. 2 is a functional block diagram of the ATTS-ECU 16.

The yaw rate sensor 23, the four vehicle speed sensors 21, the steering angle sensor 22, and the horizontal acceleration rate sensor 24 are connected to the ATTS-ECU 16. Moreover, the ATTS-ECU 16 includes a vehicle speed estimator 26 (vehicle speed detector) that estimates vehicle speed of the vehicle 1 based on detection values of the four vehicle speed sensors 21. Moreover, image data captured by the camera 25 (FIG. 1) is inputted into the ATTS-ECU 16.

The ATTS-ECU 16 controls the left-right drive force distribution device 13 based on detection values of these sensors and continuously changes the drive force distribution between the left and right front wheels 4fl and 4fr to improve a turning performance of the vehicle 1 (details are described, illustration is omitted).

The ATTS-ECU 16 includes an attitude controller 31 that controls the left-right drive force distribution device 13 being the controlled device such that a traveling attitude of the vehicle is converged to a target attitude. The drive force distribution between the left and right front wheels 4fl and 4fr is thereby changed such that the traveling attitude of the vehicle is converged to the target attitude. Moreover, a limiter 32 limits output of the left-right drive force distribution device 13 when abnormality is detected in at least one of the sensors that detect control parameters used by the left-right drive force distribution device 13 or the ATTS-ECU 16. Specifically, the drive force distribution between the left and right front wheels 4fl and 4fr is limited.

A yaw rate detector 33 directly detects the yaw rate of the vehicle 1 by using the yaw rate sensor 23 and also detects the yaw rate by using other means (details are described later).

As described above, the limiter 32 limits output of the left-right drive force distribution device 13 when abnormality is detected in at least one of the sensors that detect control parameters used by the left-right drive force distribution device 13 or the ATTS-ECU 16. Accordingly, a limit value is provided for a control amount of the left-right drive force distribution device 13 by the ATTS-ECU 16.

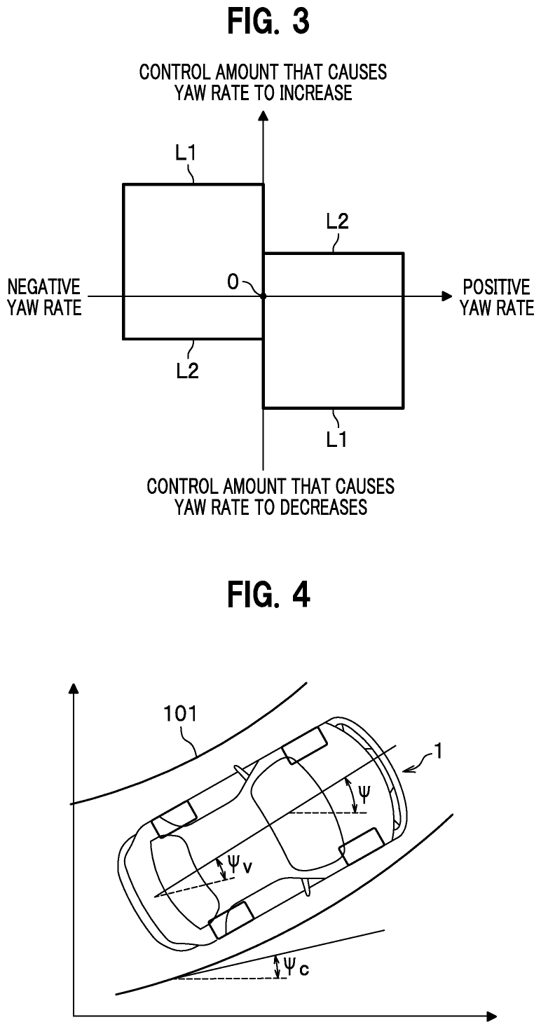

The limit value is described. FIG. 3 is a concept graph explaining the limit value for the control amount of the left-right drive force distribution device 13 by the ATTS-ECU 16. In the graph of FIG. 3, the horizontal axis represents a value of a yaw rate detected by the yaw rate detector 33. The yaw rate takes a positive value on the right side of 0 and takes a negative value on the left side of 0. The vertical axis represents a value of the control amount outputted from the ATTS-ECU 16 to the left-right drive force distribution device 13. The control amount takes a positive value above 0 and takes a negative value below 0.

The limiter 32 sets a second limit value L2 (absolute value) for a control amount that causes the yaw rate to change in a direction away from 0, to a value smaller than a first limit value L1 for a control amount that causes the yaw rate to change in a direction toward 0.

Four regions (quadrants) sectioned by the horizontal axis and the vertical axis of FIG. 3 are assumed to be such that the upper right region is the first quadrant and the other regions are the second quadrant, the third quadrant, and the fourth quadrant in counterclockwise order from the first quadrant. In this case, the control amount that causes the yaw rate to change in the direction toward 0 is the case where the detected yaw rate takes a negative value and the control amount is a control amount that causes the yaw rate to increase (second quadrant in FIG. 3) and the case where the detected yaw rate takes a positive value and the control amount is a control amount that causes the yaw rate to decreases (fourth quadrant in FIG. 3) (control in a direction in which the yaw rate becomes stable). In this case, the limit value for the control amount is set to the first limit value L1 with a large absolute value.

The control amount that causes the yaw rate to change in a direction away from 0 is the case where the detected yaw rate takes a negative value and the control amount is a control amount that causes the yaw rate to decrease (third quadrant in FIG. 3) and the case where the detected yaw rate takes a positive value and the control amount is a control amount that causes the yaw rate to increase (first quadrant in FIG. 3) (control in a direction in which the yaw rate spreads). In this case, the absolute value of the limit value for the control amount is set to the second limit value L2 smaller than the first limit value L1.

Setting the limit value for the control amount as described above allows the limit value for the control amount that causes the yaw rate to change in a stabilizing direction to be set to a value larger than the limit value for the control amount that causes the yaw rate to change in a spreading direction, also when abnormality or the like occurs in the sensors. Accordingly, control in the stabilizing direction can be sufficiently performed also in occurrence of abnormality or the like. Thus, high control performance can be maintained also when abnormality is detected in the sensors that detect the control parameters.

The yaw rate detector 33 directly detects the yaw rate of the vehicle 1 by using the yaw rate sensor 23 and also obtains an estimated yaw rate. The estimated yaw rate is obtained by using the horizontal acceleration rate obtained by the horizontal acceleration rate sensor 24 (horizontal acceleration rate detector) and the vehicle speed estimated by the vehicle speed estimator 26 (vehicle speed detector), based on “estimated yaw rate=horizontal acceleration rate/vehicle speed”.

When there is no correlation between the estimated yaw rate and the yaw rate detected by the yaw rate sensor 23, the limiter 32 sets the aforementioned first limit value L1 to a value smaller than that in the case where there is a correlation. “There is no correlation” refers to the case where a difference between the value of the estimated yaw rate and the value of the yaw rate detected by the yaw rate sensor 23 is a predetermined value or more.

The case where there is no correlation between the estimated yaw rate and the yaw rate detected by the yaw rate sensor 23 is the case where the value of the yaw rate detected by the yaw rate sensor 23 is abnormal. In this case, the limiter 32 cannot determine whether the yaw rate becomes stable. Accordingly, the limiter 32 reduces the first limit value L1 to improve stability of the vehicle 1.

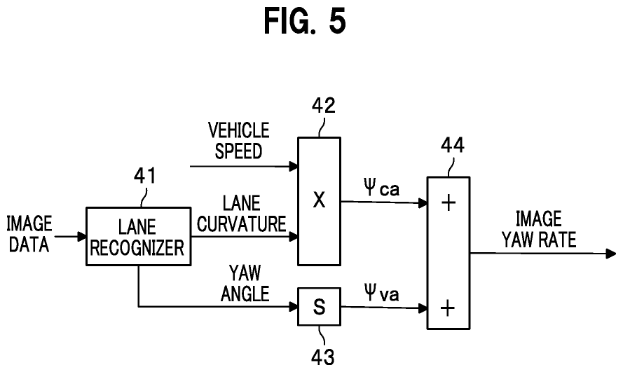

The yaw rate detector 33 also calculates an image yaw rate. FIG. 4 is a plan view of the vehicle 1 traveling in a lane. FIG. 5 is a functional block diagram of means for calculating the image yaw rate executed by the yaw rate detector 33.

First, with reference to FIG. 4, Ψ is a yaw angle with respect to the inertial frame of reference of the vehicle 1. Ψᵥ is a yaw rate deviation with respect to a lane 101 of the vehicle 1. Ψ_{c} is a direction of the lane 101 with respect to the inertial frame of reference. The yaw angle satisfies Ψ=Ψᵥ+Ψ_{c} and a value obtained by differentiating this yaw angle is the yaw rate.

The calculation of the image yaw rate is described with reference to FIG. 5. The image yaw rate is the yaw rate of the vehicle 1 calculated based on an image of the outside of the vehicle. First, a lane recognizer 41 obtains a lane curvature of the vehicle 1 with respect to the lane 101 (white line) and the yaw angle of the vehicle 1 with respect to the lane 101 from image data of a vehicle forward-view image captured by the camera 25.

A first calculator 42 multiplies the vehicle speed of the vehicle 1 estimated by the vehicle speed estimator 26 by the lane curvature with respect to the lane 101 obtained by the lane recognizer 41 to obtain a change rate Ψ_{ca} of the direction Ψ_{c} of the lane 101 per unit time.

A second calculator 43 obtains a change rate Ψᵥₐ of the yaw angle (Ψᵥ) of the vehicle 1 with respect to the lane per unit time.

A third calculator 44 adds up the change rate Ψ_{ca} and the change rate Ψᵥₐ to obtain the yaw rate (image yaw rate) of the vehicle 1.

When there is a correlation between the aforementioned estimated yaw rate and at least one of the image yaw rate or the yaw rate detected by the yaw rate sensor 23, the limiter 32 maintains the state where the first limit value is larger than the second limit value. In this case, “there is a correlation” refers to a state where a difference between the estimated yaw rate and at least one of the image yaw rate or the yaw rate detected by the yaw rate sensor 23 is not equal to or higher than a predetermined value.

In this case, the limiter 32 can determine that the yaw rate becomes stable. Accordingly, the limiter 32 maintains the state where the first limit value L1 is large and a high control performance can be maintained also when abnormality is detected in the sensors configured to detect the control parameters.

Although the example in which the controlled device is the left-right drive force distribution device 13 is described in the aforementioned example, the controlled device may be a steering device, a drive source (engine, motor), a brake, or the like. Also in such a case, it is only necessary to provide an attitude control device that controls the controlled device such that the traveling attitude of the vehicle 1 is converged to a target attitude and to set limit values like those described above for a control amount of the attitude control device.

What is claimed is:

1. An attitude control device comprising:
an attitude controller that controls a controlled device such that a traveling attitude of a vehicle is converged to a target attitude;
a limiter that limits output of the attitude controller when abnormality is detected in at least one of detectors configured to detect control parameters used by the controlled device or the attitude controller; and
a yaw rate detector that detects a yaw rate of the vehicle, wherein
the limiter sets a second limit value for a control amount that causes the yaw rate to change in a direction away from 0, to a value smaller than a first limit value for a control amount that causes the yaw rate to change in a direction toward 0.

2. The attitude control device according to claim 1, further comprising:
a horizontal acceleration rate detector that detects a horizontal acceleration rate; and
a vehicle speed detector that detects vehicle speed of the vehicle, wherein
the limiter reduces the first limit value when there is no correlation between the yaw rate detected by the yaw rate detector and an estimated yaw rate obtained from the horizontal acceleration rate and the vehicle speed.

3. The attitude control device according to claim 2, wherein
the yaw rate detector acquires an image yaw rate obtained from a vehicle forward-view image and a sensor yaw rate detected by a yaw rate sensor, and
when there is a correlation between the estimated yaw rate and at least one of the image yaw rate and the sensor yaw rate, the limiter maintains the state where the first limit value is larger than the second limit value.
